(19) United States
(12) Patent Application Publication
(10) Pub. No.: US 2025/0222402 A1
(43) Pub. Date: Jul. 10, 2025

(54) LITHIUM ISOTOPE SEPARATION METHOD AND LITHIUM ISOTOPE SEPARATION DEVICE

(71) Applicants: Kyoto Fusioneering Ltd., Uji-shi (JP); Kyoto University, Kyoto-shi (JP)

(72) Inventors: Satoshi KONISHI, Uji-shi (JP); Juro YAGI, Kyoto-shi (JP); Ryo ITO, Kyoto-shi (JP)

(21) Appl. No.: 19/089,012

(22) Filed: Mar. 25, 2025

Related U.S. Application Data
(63) Continuation of application No. PCT/JP2023/034910, filed on Sep. 26, 2023.

(30) Foreign Application Priority Data
Oct. 14, 2022 (JP) 2022-165709

(51) Int. Cl. B01D 59/32

(52) U.S. Cl. CPC B01D 59/32

(57) ABSTRACT

A lithium isotope separation device includes a mixing container 10 for bringing a medium 1 and a medium 2 into contact with each other to mix them, a mixing means 11 configured to bring the medium 1 and the medium 2 into contact with each other by allowing the medium 1 and the medium 2 to flow in the mixing container 10 to mix them, and extraction means 10a and 10b configured to separate the mixed respective liquid media by utilizing a difference in specific gravity of respective liquid media and extract each of the separated and concentrated lithium isotopes.

### CROSS-REFERENCE TO RELATED APPLICATIONS

This application claims the benefit of priority and is a Continuation application of the prior International Patent Application No. PCT/JP2023/034910, with an international filing date of Sep. 26, 2023, which designated the United States, and is related to the Japanese Patent Application 2022-165709, filed Oct. 14, 2022, the entire disclosures of all applications are expressly incorporated by reference in their entirety herein.

### TECHNICAL FIELD

The present invention relates to a lithium isotope separation method and a lithium isotope separation device for separating isotopes of lithium 6 and 7 by contact of two different liquids without applying particularly large energy.

### BACKGROUND OF THE INVENTION

Lithium consists of two stable isotopes: lithium-6 (6Li) (7.5%) and lithium-7 (7Li) (92.5%). Lithium isotopes are increasingly demanded in recent years in the field of nuclear power. 6Li has a large thermal neutron absorption cross section (about 947 burn), and is used as a radiation shielding, control material or a blanket material for lithium growth in a nuclear fusion reactor. 7Li has excellent thermodynamic and thermal transfer characteristics and has a small thermal neutron absorption cross section, and thus is used as an acidity regulator for primary cooling water in a light water cooling reactor (PWR).

Conventionally, lithium isotopes are separated on an industrial scale by a type of amalgam method called Colex method, or are separated by substitution chromatography using a strongly acidic cation exchange resin as an absorbent (see Patent Literature 1).

### PRIOR ART

### Patent Documents

Patent Literature 1: JP 59-145022 A

### SUMMARY OF THE INVENTION

### Problem to be Solved by the Invention

However, since the amalgam method described above handles a large amount of mercury, there is a risk of environmental pollution and health damage to workers.

Therefore, the present invention solves such a problem, and an object thereof is to provide a lithium isotope separation method and a lithium isotope separation device capable of improving separation efficiency while avoiding environmental pollution and health damage of workers when separating lithium isotopes.

### Means for Solving the Problems

In order to solve the above problem, a lithium isotope separation method of the present invention includes an isotope transfer step of bringing a first liquid medium and a second liquid medium each including a plurality of lithium isotopes into contact with each other to mutually exchange and transfer the lithium isotopes from one liquid medium to another liquid medium according to their mass numbers, in which
the first liquid medium is a molten metal containing a molten liquid of an alloy of metallic lithium and a chemically inert metal, and
the second liquid medium is a molten salt containing lithium and a molten liquid of a salt containing a compound of a halogen element.

In the above invention, in the isotope transfer step, it is preferable that the exchange transfer of the lithium isotopes is promoted by allowing the first liquid medium and the second liquid medium to flow in a same container.

In the above invention, it is preferable that a lithium lead alloy or a lithium tin alloy with a low melting point and a eutectic alloy containing the lithium lead alloy or the lithium tin alloy are used as the molten metal, and a molten salt containing alkali metal ions that are not reactive with the molten metal, such as lithium chloride, bromide, or iodide, is used as the molten salt.

The step of exchanging and transferring the isotopes in the above invention preferably includes:
supplying the first liquid medium and the second liquid medium into a container and mixing the first liquid medium and the second liquid medium; and
separating the lithium isotopes by utilizing a difference in specific gravity of respective liquid media, thereby extracting the concentrated lithium isotopes through a pair of discharge ports attached to the container.

In addition, the method for separating lithium isotopes described above can be implemented by operating the lithium isotope separation device of the present invention. That is, the present invention provides a lithium isotope separation device for separating and extracting two or more lithium isotopes using a property that lithium isotopes are mutually exchanged and transferred from one liquid medium to another liquid medium according to their mass numbers by bringing a first liquid medium into contact with a second liquid medium,
in which the lithium isotope separation device includes:
a mixing container for bringing the first liquid medium and the second liquid medium into contact with each other to mix the first liquid medium and the second liquid medium;
a mixing means configured to bring the first liquid medium and the second liquid medium into contact with each other by allowing the first liquid medium and the second liquid medium to flow in the mixing container to mix the first liquid medium and the second liquid medium; and
an extraction means configured to separate the respective liquid media mixed by the mixing means by utilizing a fact that the respective liquid media do not melt each other and have a difference in specific gravity, and extract each of the separated and concentrated lithium isotopes through a pair of discharge ports.

In the above invention, it is possible to use a molten metal containing a molten liquid of an alloy of metallic lithium and a chemically inert metal as the first liquid medium, and a molten salt containing lithium and a molten liquid of a salt containing a compound of a halogen element as the second liquid medium.

In the above invention, it is preferable that the mixing means is connected in a plurality of stages or performs countercurrent liquid transport in opposite directions to each other to superimpose an isotope separation effect. Also, in the above invention, it is preferable that a lithium lead alloy or a lithium tin alloy with a low melting point and a eutectic alloy containing the lithium lead alloy or the lithium tin alloy are used as the molten metal, and a molten salt having a low melting point containing alkali metal ions that are not reactive with the molten metal, such as lithium chloride, bromide, or iodide, is used as the molten salt.

### Effects of the Invention

According to the present invention, when lithium isotopes are separated, a property that lithium isotopes are mutually exchanged and transferred from one liquid medium to the other liquid medium according to their mass numbers by bringing a first liquid medium containing a molten metal into contact with a second liquid medium containing a molten salt is used. Thus, according to the present invention, since an alloy of lithium and other inert metal is used instead of the conventional lithium amalgam, and a molten salt having no reactivity with the lithium alloy is used instead of the aqueous solution, it is possible to utilize the separation effect while avoiding environmental pollution and health damage of workers.

### BRIEF DESCRIPTION OF DRAWINGS

FIG. 1 is an explanatory view schematically showing a configuration of a lithium isotope separation device according to a first embodiment.

FIG. 2 is an explanatory view schematically showing a schematic configuration of a lithium isotope separation device according to a second embodiment.

FIG. 3 is an explanatory view schematically showing a schematic configuration of a lithium isotope separation device according to a third embodiment.

FIG. 4 is an explanatory view schematically showing a schematic configuration of a lithium isotope separation device according to a fourth embodiment.

### DETAILED DESCRIPTION OF THE INVENTION

Hereinafter, embodiments of the present invention will be described in detail. Each embodiment described below exemplifies a device and the like for embodying the technical idea of the present invention, and the technical idea of the present invention does not specify the material, shape, structure, arrangement, and the like of each component to the followings. Various modifications can be made to the technical idea of the present invention within the scope of the claims. However, unlike amalgam, these liquid media are solid at room temperature and need to be used at a temperature equal to or higher than the melting point, and thus all the containers used are heat-insulated.

### First Embodiment

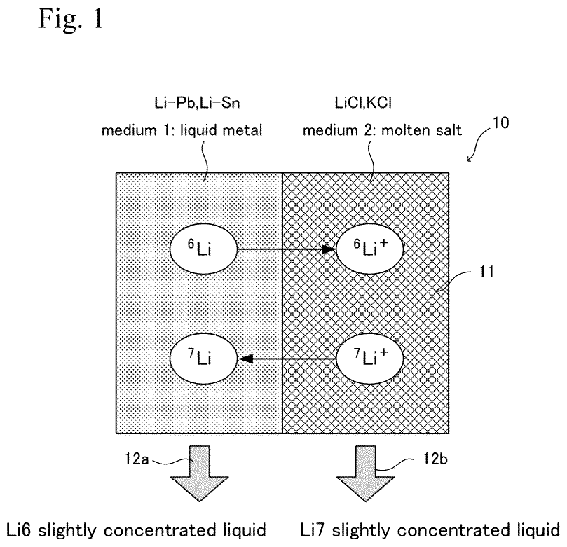

First, a first embodiment of the present invention will be described. FIG. 1 illustrates a configuration of a separation device according to an embodiment.

As shown in the same figure, the lithium isotope separation device is a lithium isotope separation device for separating and extracting two or more lithium isotopes using a property that lithium isotopes are mutually exchanged and transferred from one liquid medium to the other liquid medium according to their mass numbers by bringing a medium 1 that is a first liquid medium into contact with a medium 2 that is a second liquid medium.

Specifically, the lithium isotope separation device includes a mixing container 10 for bringing the medium 1 and the medium 2 into contact with each other to mix them, a mixing means 11 configured to bring the medium 1 and the medium 2 into contact with each other by allowing the medium 1 and the medium 2 to flow in the mixing container 10 to mix them, and extraction ports 12a and 12b configured to separate the mixed respective liquid media by utilizing a difference in specific gravity of respective liquid media and extract each of the separated and concentrated lithium isotopes through a pair of nozzles or the like.

In the present embodiment, the first medium 1 is a molten metal containing a molten liquid of an alloy of metallic lithium and a chemically inert metal, and the second medium 2 is a molten salt containing lithium and a molten liquid of a salt containing a compound of a halogen element. As the molten metal contained in the first medium 1, a lithium lead alloy or a lithium tin alloy with a low melting point, such as Li—Pb or Li—Sn, and a eutectic alloy containing these can be used, and as the molten salt contained in the second medium 2, a molten salt containing alkali metal ions that are not reactive with the molten metal, such as lithium chloride, bromide, or iodide, such as LiCl or KCl can be used.

The alloy of lithium and lead has a melting point of about 230° C., and on the other hand, a melting point of about 300° C. can be achieved by using a eutectic salt of lithium chloride and other alkali metal halide. In the present embodiment, heat insulation is applied to the mixing container 10, and the respective media are mixed in a liquid state. In this mixing treatment, the respective media may be stirred or convected.

As described above, by connecting the medium 1 and the medium 2 that are liquids containing the molten metal and the molten salt to each other, lithium isotopes with different mass numbers can be mutually exchanged and transferred from one liquid medium to the other liquid medium using the difference in mass numbers of lithium isotopes, and can be separated as a Li6 slightly concentrated liquid and a Li7 slightly concentrated liquid. Here, for convenience of explanation, it is expressed as if the lithium isotope is exchanged and transferred in a horizontal direction, but in this separation treatment, for example, various separation methods such as a vertical direction and a horizontal direction can be used, such as allowing the lithium isotope having a large specific gravity to precipitate by standing after mixing, or performing centrifugal separation, and the position and method of the extraction ports 12a and 12b as means for extracting (discharging) the separated isotopes can be appropriately set according to the separation method.

As the molten metal contained in the medium 1, a simple substance Li can also be used, but in this case, it is necessary to avoid contact with the atmosphere because of ignitability. In addition, a mixture of LiCl, LiBr, or Lil, or KCl, KBr, Kl, RbCl, RbBr, RbI, CsCl, CsBr, or CsI may be appropriately selected alone or a plurality of kinds and mixed therewith. In general, the isotope effect is larger as the temperature is lower, and the solidifying point of the alloy and the compound is lowered by mixing. Therefore, it is preferable to mix them so that the melting point is as low as possible.

### Second Embodiment

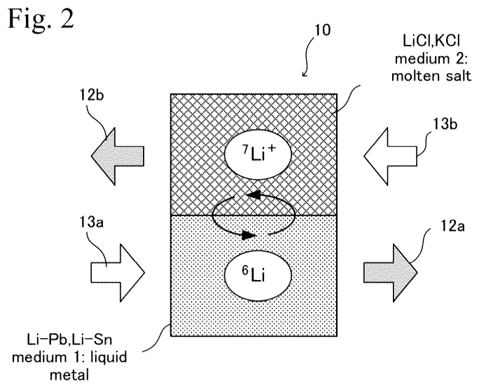

Next, a second embodiment of the present invention will be described. The liquids of the medium 1 and the medium 2 described above are hardly mixed due to a large difference in specific gravity. Therefore, in the present embodiment, the liquids are distributed while being continuously brought into contact with each other by vertically attaching two pairs of inlet and outlet ports to one mixing container 10 as shown in FIG. 2.

Specifically, a supply port 13b and a discharge port 12b through which the medium 2 is distributed are provided in an upper part of the mixing container 10, and a supply port 13a and a discharge port 12a through which the medium 1 is distributed are provided in a lower part of the mixing container 10. At the upper part of the mixing container 10, the medium 2 is continuously supplied from the supply port 13b and is discharged from the discharge port 12b, and the medium 2 is further supplied from the supply port 13b to circulate. On the other hand, in the lower part of the mixing container 10, the medium 1 is continuously supplied from the supply port 13a and is discharged from the discharge port 12a, and the medium 1 is further supplied from the supply port 13a to circulate. At this time, also in the present embodiment, heat insulation is applied to the mixing container 10, and the respective media are distributed in a liquid state.

As a result, in a middle layer of the mixing container 10, the medium 1 distributed in the upper part and the medium 2 distributed in the lower part are brought into contact with each other, and according to the specific gravity (mass number) of the isotopes contained in both parts, the Li7 slightly concentrated liquid having a large specific gravity transfers to the lower part of the mixing container 10, the Li6 slightly concentrated liquid having a small specific gravity transfers to the upper part of the mixing container 10, and continuously circulates in the upper part and the lower part, so that the isotopes are separated vertically and respectively concentrated, and discharged as the Li6 slightly concentrated liquid and the Li7 slightly concentrated liquid from the discharge ports 12a and 12b, respectively.

### Third Embodiment

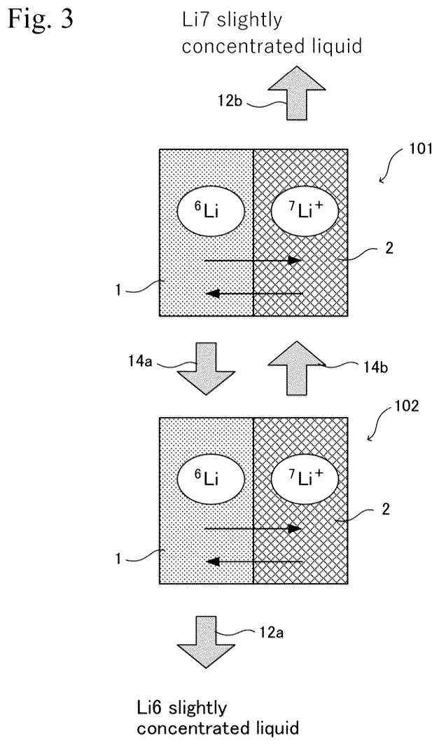

Next, a third embodiment of the present invention will be described. In the present embodiment, the above-described mixing containers are set as liquid mixing tanks 101 and 102 continuously provided in a plurality of stages (two stages in the illustrated example) as shown in FIG. 3. Also in the present embodiment, heat insulation is applied to the liquid mixing tanks 101 and 102, and the respective media are distributed in a liquid state.

The liquid mixing tanks 101 and 102 are sequentially connected in a cascade manner from the front stage to the rear stage by extraction medium delivery means 14a and 14b, and the liquid medium separated and concentrated in the liquid mixing tank in the front stage is delivered to the liquid mixing tank in the rear stage (or to the liquid mixing tank in the front stage). For example, an isotope having a large specific gravity is extracted from the lower side of each tank and delivered to the rear stage, an isotope having a small specific gravity is extracted from the upper side of each layer and delivered to the front stage, and the isotopes are sequentially separated and concentrated by repeating cascade, and are discharged as a Li6 slightly concentrated liquid and a Li7 slightly concentrated liquid from the discharge ports 12a and 12b of the liquid mixing tanks in the foremost stage or the rearmost stage, respectively.

As a result, the separation effect can be superimposed by connecting the mixing containers in a plurality of stages like the liquid mixing tanks 101 and 102. Also in the present embodiment, for convenience of explanation, it is expressed as if the lithium isotope is exchanged and transferred in a horizontal direction, but as in the above-described embodiment, for example, various separation methods such as a vertical direction and a horizontal direction can be used, such as allowing the lithium isotope having a large specific gravity to precipitate by standing after mixing, or performing centrifugal separation, and the liquid mixing tanks 101 and 102 can also be connected in the vertical direction and the horizontal direction. In addition, the position and system of the extraction (discharge) means of the isotope separated in each tank and the extraction medium delivery means 14a and 14b as the supply means of the extracted medium to the next tank can also be appropriately selected according to the separation method.

### Fourth Embodiment

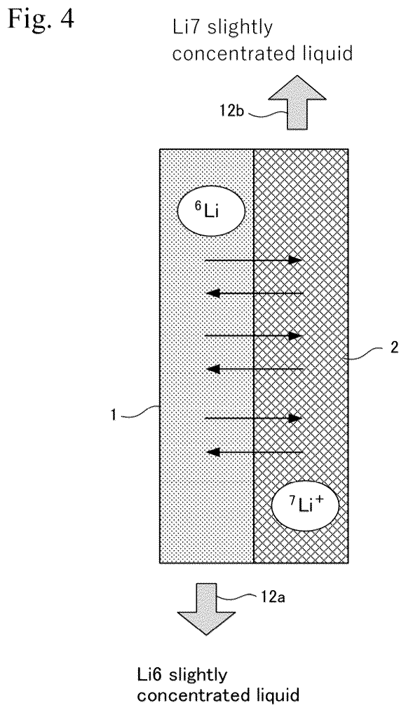

Further, a fourth embodiment of the present invention will be described. In the present embodiment, the liquid mixing tanks 101 and 102 of the third embodiment described above are integrated and formed as one vertically or horizontally long mixing container as shown in FIG. 4. Also in the present embodiment, heat insulation is applied to the liquid mixing tanks 101 and 102, and the respective media are distributed in a liquid state.

In such a vertically or horizontally long mixing container, for example, at each height position in the container, the isotope having a large specific gravity is exchanged and transferred from the upper side to the lower side of the mixing container, the isotope having a small specific gravity is exchanged and transferred from the lower side to the upper side of the mixing container, and such exchange transfer is repeated steplessly in the height direction in the container, whereby the isotopes are sequentially separated and concentrated, and are discharged as the Li6 slightly concentrated liquid and the Li7 slightly concentrated liquid from discharge ports 12a and 12b in the uppermost part or the lowermost part, respectively. As a result, it is possible to increase the contact area or the contact time between the medium 1 and the medium 2, and further, it is possible to obtain an effect of virtually connecting multistage devices in a plurality of stages by the countercurrent contact effect as in the third embodiment, and to improve the separation effect.

Note that the present invention is not limited to the above-described embodiments as they are, and the components can be modified and embodied without departing from the gist thereof in the implementation stage. In addition, various inventions can be formed by appropriately combining a plurality of components disclosed in the above embodiments. For example, some components may be deleted from all the components shown in the embodiments.

### REFERENCE SIGNS LIST

1 First liquid medium (medium 1: liquid metal)
2 Second liquid medium (medium 2: molten salt)
10 Mixing container
11 Mixing means
12a Discharge port (Li6 slightly concentrated liquid)
12b Discharge port (Li7 slightly concentrated liquid)
13a Supply port (medium 1: liquid metal)
13b Supply port (medium 2: molten salt)
14a, 14b Extraction medium delivery means
101, 102 Liquid mixing tank

1. A lithium isotope separation method, comprising:
an isotope transfer step of bringing a first liquid medium and a second liquid medium each including a plurality of lithium isotopes into contact with each other to mutually exchange and transfer the lithium isotopes from one liquid medium to another liquid medium according to their mass numbers, wherein
the first liquid medium is a molten metal containing a molten liquid of an alloy of metallic lithium and a chemically inert metal, and
the second liquid medium is a molten salt containing lithium and a molten liquid of a salt containing a compound of a halogen element.

2. The lithium isotope separation method according to claim 1, wherein in the isotope transfer step, the exchange transfer of the lithium isotopes is promoted by allowing the first liquid medium and the second liquid medium to flow in a same container.

3. The lithium isotope separation method according to claim 1, wherein
a lithium lead alloy or a lithium tin alloy with a low melting point and a eutectic alloy containing the lithium lead alloy or the lithium tin alloy are used as the molten metal, and
a low melting point molten salt containing alkali metal ions that are not reactive with the molten metal, such as lithium chloride, bromide, or iodide, is used as the molten salt.

4. The lithium isotope separation method according to claim 1, wherein
the isotope transfer step includes:
supplying the first liquid medium and the second liquid medium into a container and mixing the first liquid medium and the second liquid medium; and
separating the lithium isotopes by utilizing a fact that the respective liquid media do not dissolve each other and have a difference in specific gravity, thereby extracting the concentrated lithium isotope through a pair of discharge ports attached to the container.

5. A lithium isotope separation device for separating and extracting two or more lithium isotopes using a property that lithium isotopes are mutually exchanged and transferred from one liquid medium to another liquid medium according to their mass numbers by bringing a first liquid medium into contact with a second liquid medium,
wherein the lithium isotope separation device comprises:
a mixing container for bringing the first liquid medium and the second liquid medium into contact with each other to mix the first liquid medium and the second liquid medium;
a mixing means configured to bring the first liquid medium and the second liquid medium into contact with each other by allowing the first liquid medium and the second liquid medium to flow in the mixing container to mix the first liquid medium and the second liquid medium; and
an extraction means configured to separate the respective liquid media mixed by the mixing means by utilizing a fact that the respective liquid media do not dissolve each other and have a difference in specific gravity, and extract each of the separated and concentrated lithium isotopes through a pair of discharge ports,
the first liquid medium is a molten metal containing a molten liquid of an alloy of metallic lithium and a chemically inert metal, and
the second liquid medium is a molten salt containing lithium and a molten liquid of a salt containing a compound of a halogen element.

6. The lithium isotope separation device according to claim 5, wherein the mixing means is connected in a plurality of stages to superimpose an isotope separation effect.

7. The lithium isotope separation device according to claim 5, wherein the mixing means performs countercurrent liquid transport in opposite directions to each other to superimpose an isotope separation effect.

8. The lithium isotope separation device according to claim 5, wherein
a lithium lead alloy or a lithium tin alloy with a low melting point and a eutectic alloy containing the lithium lead alloy or the lithium tin alloy are used as the molten metal, and
a low melting point molten salt containing alkali metal ions that are not reactive with the molten metal, such as lithium chloride, bromide, or iodide, is used as the molten salt.
